(19) United States
(12) Patent Application Publication
(10) Pub. No.: US 2007/0060710 A1
(43) Pub. Date: Mar. 15, 2007

(54) Rubber latex and method for preparing the same

(76) Inventors: Ok-yeol Jeong, Jeollanam-do (KR); Geon-soo Kim, Jeollanam-do (KR); Chan-hong Lee, Daejeon (KR); Young-sim Kim, Jeollanam-do (KR)

Correspondence Address: CANTOR COLBURN, LLP, 55 GRIFFIN ROAD SOUTH, BLOOMFIELD, CT, 06002, US

(21) Appl. No.: 10/570,714

(22) PCT Filed: Oct. 29, 2004
(86) PCT No.: PCT/KR04/02754

§ 371 Date: Mar. 6, 2006

(30) Foreign Application Priority Data
Oct. 29, 2003 (KR) 10-2003-0076046

(51) Int. Cl. C08F 297/02

(52) U.S. Cl. 525/242

(57) ABSTRACT

Provided are a rubber latex used as a substrate for an impact modifier, a preparation method thereof, and an impact modifier prepared using the rubber latex. The rubber latex includes a rubber monomer as a main component and has a decreasing gel content from a core to a shell(s). The preparation method includes polymerizing a core followed by polymerization of a shell(s) has a lower gel content that the core. The impact modifier is prepared by common graft polymerization using the rubber latex as a substrate. The rubber latex has a high gel content core and a low gel content shell (s), and thus, is free from problems involved in low or high gel content rubber particles. The rubber latex can be used as a substrate for a high efficiency impact modifier with high rubber content and enhanced impact strength and processability.

### TECHNICAL FIELD

The present invention relates to a rubber latex used as a substrate for an impact modifier and a preparation method thereof. With respect to impact modifiers prepared from common low gel content rubber latex particles, due to the limitation of grafting, insertion of the outermost layer polymer into the rubber latex particles occurs. On the other hand, impact modifiers prepared from common high gel content rubber latex particles have a low impact strength. The present invention has been made in view of these problems. More particularly, the present invention relates to a rubber latex having a decreasing gel content from a latex particle core to a latex particle shell, which can be used in preparation of a high efficiency impact modifier with high rubber content and enhanced impact strength and processability, and a preparation method thereof.

### BACKGROUND ART

Generally, an impact modifier has enhanced impact strength and processability by grafting onto a rubber particle substrate. In particular, a high efficiency impact modifier is accomplished by a high rubber content. However, with respect to low gel content rubber particles, the outermost layer polymer is inserted into the rubber particles due to the limitation of grafting, which makes it difficult to significantly increase a rubber content in an impact modifier. On the other hand, with respect to high gel content rubber particles, even though a rubber content in an impact modifier can be increased, there is a problem in that an impact strength is not significantly increased.

### DISCLOSURE OF INVENTION

In view of these problems, the present invention provides a rubber latex having a decreasing gel content from a latex particle core to a latex particle shell and a preparation method thereof.

The present invention also provides a high efficiency impact modifier using the rubber latex as a substrate.

The above and other objects of the present invention can be accomplished by embodiments of the present invention as will be described hereinafter.

Hereinafter, the present invention will be described in more detail.

The present invention provides a rubber latex including a rubber monomer as a main component, wherein the rubber latex is composed of a core and one or more shells and has a decreasing gel content from the core to the shells.

In the rubber latex of the present invention, the gel content of the core may be 90 to 100%, the average gel content of the shells may be 70 to 90%, and the gel content of the rubber latex may be 85 to 95%.

The rubber monomer may be one or more selected from the group consisting of a conjugated diene compound, for example 1,3-butadiene, isoprene, chloroprene, piperylene, or a comonomer thereof; alkyl acrylate; and silicon-based monomer.

The rubber latex may have an average particle size of 500 to 8,000 Å, and preferably 800 to 5,000 Å.

The present invention also provides a method for preparing a rubber latex having a gel content of 85 to 95% and including a rubber monomer as a main component, the method including: polymerizing a core and polymerizing one or more shells onto the core so that the shells have a lower gel content than the core.

In the core polymerization, the gel content of the core may be 90 to 100%.

In the shell polymerization, the average gel content of the shells may be 70 to 90%.

The rubber monomer may be one or more selected from the group consisting of a conjugated diene compound, for example 1,3-butadiene, isoprene, chloroprene, piperylene, or a comonomer thereof; alkyl acrylate; and silicon-based monomer. In detail, the rubber monomer may be at least one selected from the group consisting of a conjugated diene compound such as 1,3-butadiene, isoprene, chloroprene, piperylene, and a comonomer thereof; alkyl acrylate with an alkyl moiety of 2-8 carbon atoms such as ethyl acrylate, propyl acrylate, isopropyl acrylate, butyl acrylate, 2-ethylhexyl acrylate, and octyl acrylate; and alkyl methacrylate with an alkyl moiety of 2-8 carbon atoms such as methyl methacrylate, butyl methacrylate, and benzyl methacrylate; and a silicon-based monomer such as octamethylcyclotetrasiloxane.

The rubber latex may further include an aromatic vinyl monomer selected from styrene, alphamethylstyrene, vinyl toluene, 3,4-dichlorostyrene, and a mixture thereof according to the type of a matrix polymer requiring the addition of an impact modifier. Alternatively, the rubber latex may further include vinyl cyanide such as acrylonitrile and methacrylonitrile or vinylidene cyanide alone or in combination with the aromatic vinyl monomer.

The particle structure of the rubber latex of the present invention is controlled by a multi-step polymerization process. The rubber latex of the present invention is prepared by polymerizing a core followed by polymerization of one or more shell layers onto the core. The rubber latex of the present invention may have one up to five shell layers, and preferably one up to three shell layers.

In the core polymerization, the rubber monomer may be used in an amount of 5 to 90 parts by weight, and preferably 10 to 85 parts by weight, based on 100 parts by weight of all monomers constituting the rubber latex of the present invention.

According to the type of a matrix polymer, aromatic vinyl monomer, vinyl cyanide, vinylidene cyanide, or a mixture thereof may be used in an amount of 100 parts by weight or less, based on 100 parts by weight of the rubber monomer used in the core polymerization.

When needed, a graft crosslinking agent may be further used in an amount of 5 parts by weight or less, based on 100 parts by weight of the rubber monomer used in the core polymerization, to increase the gel content of the core. Preferably, the graft crosslinking agent may be one or more selected from the group consisting of divinylbenzene, ethyleneglycoldimethacrylate, 1,3-methyleneglycoldimethacrylate, triethyleneglycoldimethacrylate, arylmethacrylate, and 1,3-butyleneglycoldiacrylate.

In the present invention, the gel content of the core can also be increased by inducing a monomer-to-polymer conversion ratio of 90% or more, preferably 95% or more, or increasing a polymerization temperature, in addition to the use of the graft crosslinking agent. At this time, the gel content of core particles prepared is 90 to 100%, and preferably 95 to 100%.

In the shell polymerization of the present invention, the rubber monomer is used in an amount of 10 to 95 parts by weight, and preferably 15 to 90 parts by weight. When needed, there may be formed one up to five shell layers, and preferably one up to three shell layers, using a molecular weight adjuster. In the case of forming two or more shell layers, the shell layers may have the same or different composition and content of monomers.

In the case of forming two or more shell layers, the shell layers have different gel contents. That is, the gel content of a first shell layer coated on the core is adjusted to 1 to 20% lower than that of the core. Similarly, the gel content of a second shell layer coated on the first shell layer is adjusted to 1 to 20% lower than that of the first shell layer. At this time, an average gel content of the shell layers thus formed is adjusted to 70 to 90%, and preferably 80 to 90%. By doing so, final rubber latex particles can have a gel content of 80% or more, and preferably 85% or more.

To control the gel contents of the shell layers, a molecular weight adjuster can be used. The molecular weight adjuster can be used in an amount of 4 parts by weight or less, and preferably 2 parts by weight or less, based on 100 parts by weight of monomers used for the shell polymerization. In the present invention, the gel contents of the shell layers can also be decreased by inducing a monomer-to-polymer conversion ratio of 95% or less, preferably 90% or less, or decreasing a polymerization temperature, in addition to the use of the molecular weight adjuster.

In the shell polymerization of the present invention, aromatic vinyl monomer, vinyl cyanide, vinylidene cyanide, or a mixture thereof may be further used in an amount of 20 parts by weight or less, and preferably 10 parts by weight or less, based on 100 parts by weight of the rubber monomer used for the shell polymerization. If the content of aromatic vinyl monomer, vinyl cyanide, vinylidene cyanide, or a mixture thereof exceeds 20 parts by weight, the gel contents of the shell layers may increase, thereby lowering impact characteristics of an impact modifier.

The rubber latex prepared according to the method of the present invention may have an average particle size of 500 to 8,000 Å, and preferably 800 to 5,000 Å. However, a rubber latex with a particle size of 1,000 Å or less can be rapidly prepared within 12 hours, but a rubber latex with a particle size of 2,000 Å or more requires a prolonged preparation time of 20 hours or more, thereby decreasing productivity.

Generally, to obtain a resin with high impact strength, large rubber latex particles are used as a substrate for an impact modifier. In this respect, small rubber latex particles prepared according to the present invention may be further subjected to a particle size enlargement to decrease a preparation time and easily obtain desired-sized particles, which is also within the scope of the present invention. The particle size enlargement is not particularly limited and may be a method commonly used in the pertinent art. For example, small rubber latex particles prepared according to the present invention can be formed into large rubber latex particles with a controlled gel content in such a manner that small quantity of an emulsifier is added to the small rubber latex particles to increase the stability of the latex particles followed by particle fusion by addition of a weak acidic material such as acetic acid or phosphoric acid. Alternatively, particle size enlargement can also be performed by salt flocculation and cooling or using a polymer flocculant.

In detail, the emulsifier for stabilization of the latex particles may be an ammonium salt of alkaline metal or high molecular weight alkylsulfonic acid, high molecular weight alkylsulfate, aromatic sulfate derivative, ethoxylated alkylaryl phosphate, or a mixture thereof. A sulfate- or sulfonate-based emulsifier is preferred. Examples of the sulfate- or sulfonate-based emulsifier include sodium lauryl sulfate, sodium dodecylbenzene sulfonate, potassium dodecylbenzene sulfonate, and lauryl(ethoxy) sulfate or sulfonate, alkylaryl(polyethoxy) sulfate or sulfonate. Preferred examples of the weak acidic material include, but are not limited to, carbon dioxide, sulfur dioxide, acetic acid, formic acid, propionic acid, butanoic acid, tartaric acid, and phosphoric acid.

When the particle size of a rubber latex reaches a desired level using the weak acid material, a decreased pH of the rubber latex must be returned to an original pH using a sufficient amount of an alkali hydroxide aqueous solution. At this time, a potassium hydroxide solution or a sodium hydroxide solution is suitable as the alkali hydroxide aqueous solution. Sequential execution of the above-described processes can produce large rubber latex particles with a desired particle size.

The present invention also provides an impact modifier prepared by graft polymerization onto a rubber latex substrate.

The impact modifier may be used for a thermoplastic resin or a thermosetting resin.

The thermoplastic resin may be one or more selected from the group consisting of acrylonitrile butadiene styrene, styrene acrylonitrile copolymer, methylmethacrylate polymer, polyvinylchloride, polycarbonate, polyester, and polyamide.

The thermosetting resin may be an epoxy resin.

Properties and characteristics of rubber latexes are evaluated as follows.

Gel Content

A rubber latex is solidified by means of a weak acid or a metal salt, washed, and dried in a 60° C. vacuum oven for 24 hours. An obtained rubber lump is cut into rubber pieces by means of scissors. 1 g of the rubber pieces are placed in 100 g of toluene and incubated in a dark room set to room temperature for 48 hours. A sol and a gel are then separated to measure a gel content as follows:
Gel content (%)=[weight of insoluble portion (gel)/weight of test sample]×100

Particle Size and Particle Size Distribution

The particle size and particle size distribution of rubber latexes are measured according to a dynamic laser light scattering method using Nicomp 370HPL.

### MODES FOR CARRYING OUT THE INVENTION

Hereinafter, the present invention will be described more specifically by Examples. However, the following Examples are provided only for illustrations and thus the present invention is not limited to or by them.

### EXAMPLE a1

To a high-pressure polymerization reactor equipped with a stirrer, there were added 250 parts by weight of ion exchange water, 0.8 parts by weight of potassium oleic acid, 0.065 parts by weight of sodium pyrophosphate, 0.0047 parts by weight of ethylenediamine sodium tetraacetate, 0.003 parts by weight of ferrous sulfuric acid, 0.02 parts by weight of sodium formaldehyde sulfoxylate, and 0.11 parts by weight of diisopropylbenzene hydroperoxide. Then, 50 parts by weight of butadiene as a monomer and 0.5 parts by weight of divinylbenzene as a crosslinking agent were added thereto and polymerized at 50° C. to obtain a core polymer for a rubber latex.

The monomer-to-polymer conversion ratio, measured by a weight method, was 97 wt %, and the gel content of the core polymer was 95%.

For shell polymerization, 50 parts by weight of butadiene, 0.2 parts by weight of potassium oleic acid, 0.02 parts by weight of sodium formaldehyde sulfoxylate, 0.11 parts by weight of diisopropylbenzene hydroperoxide, and 0.2 parts by weight of tertiary dodecylmercaptan as a molecular weight adjuster were added to the core polymer and polymerized at 50° C. to obtain a rubber latex with a particle size of 950 Å. The overall monomer-to-polymer conversion ratio was 90 wt % and the gel content of the rubber latex finally obtained was 88%.

### EXAMPLE a2

A rubber latex was prepared in the same manner as in Example a1 except that the compositions and contents of components were as given in Table 1 below.

### EXAMPLE a3

To a high-pressure polymerization reactor equipped with a stirrer, there were added 250 parts by weight of ion exchange water, 0.8 parts by weight of potassium oleic acid, 0.065 parts by weight of sodium pyrophosphate, 0.0047 parts by weight of ethylenediamine sodium tetraacetate, 0.003 parts by weight of ferrous sulfuric acid, 0.02 parts by weight of sodium formaldehyde sulfoxylate, and 0.15 parts by weight of diisopropylbenzene hydroperoxide. Then, 35 parts by weight of butadiene, 15 parts by weight of styrene as a vinyl monomer, and 0.5 parts by weight of divinylbenzene as a crosslinking agent were added thereto and polymrized at 50° C. to obtain a core polymer for a rubber latex.

The monomer-to-polymer conversion ratio, measured by a weight method, was 98 wt %, and the gel content of the core polymer was 98%.

For shell polymerization, 45 parts by weight of butadiene, 5 parts by weight of styrene, 0.2 parts by weight of potassium oleic acid, 0.02 parts by weight of sodium formaldehyde sulfoxylate, 0.11 parts by weight of diisopropylbenzene hydroperoxide, and 0.2 parts by weight of tertiary dodecylmercaptan as a molecular weight adjuster were added to the core polymer and polymerized at 50° C. to obtain a rubber latex with a particle size of 990 Å. The overall monomer-to-polymer conversion ratio was 92 wt % and the gel content of the rubber latex finally obtained was 89%.

### EXAMPLE a4

A rubber latex was prepared in the same manner as in Example a3 except that the compositions and contents of components were as given in Table 1 below.

TABLE 1

| Section | | Example a1 | Example a2 | Example a3 | Example a4 |
|---|---|---|---|---|---|
| Core | Ion exchange water | 250 | 150 | 250 | 150 |
| | Potassium oleic acid | 0.8 | 0.4 | 0.8 | 0.4 |
| | Sodium pyrophosphate | 0.065 | 0.065 | 0.065 | 0.065 |
| | Ethylenediamine sodium tetraacetate | 0.0047 | 0.0047 | 0.0047 | 0.0047 |
| | Ferrous sulfuric acid | 0.003 | 0.003 | 0.003 | 0.003 |
| | Sodium formaldehyde sulfoxylate | 0.02 | 0.02 | 0.02 | 0.02 |
| | Diisopropylbenzene hydroperoxide | 0.11 | 0.11 | 0.15 | 0.15 |
| | Butadiene | 50 | 50 | 35 | 35 |
| | Styrene | 0 | 0 | 15 | 15 |
| | Divinylbenzene | 0.5 | 0.5 | 0.5 | 0.5 |
| | Tertiary dodecylmercaptan | 0 | 0 | 0 | 0 |
| | Monomer to polymer conversion | 97 | 95 | 98 | 93 |
| | ratio (wt %) | | | | |
| | Gel content (%) | 95 | 93 | 98 | 96 |
| Shell | Potassium oleic acid | 0.2 | 0.2 | 0.2 | 0.2 |
| | Sodium formaldehyde sulfoxylate | 0.02 | 0.02 | 0.02 | 0.02 |
| | Diisopropylbenzene hydroperoxide | 0.11 | 0.11 | 0.11 | 0.11 |
| | Butadiene | 50 | 50 | 45 | 45 |
| | Styrene | 0 | 0 | 5 | 5 |
| | Divinylbenzene | 0 | 0 | 0 | 0 |
| | Tertiary dodecylmercaptan | 0.2 | 0.2 | 0.2 | 0.2 |
| | Monomer to polymer conversion | 90 | 88 | 92 | 87 |
| | ratio (wt %) | | | | |
| | Particle size (Å) | 950 | 2010 | 990 | 1980 |
| | Final gel content (%) | 88 | 90 | 89 | 89 |

Component unit: parts by weight

### COMPARATIVE EXAMPLE a1

To a high-pressure polymerization reactor equipped with a stirrer, there were added 250 parts by weight of ion exchange water, 0.8 parts by weight of potassium oleic acid, 0.065 parts by weight of sodium pyrophosphate, 0.0047 parts by weight of ethylenediamine sodium tetraacetate, 0.003 parts by weight of ferrous sulfuric acid, 0.02 parts by weight of sodium formaldehyde sulfoxylate, and 0.11 parts by weight of diisopropylbenzene hydroperoxide. Then, 50 parts by weight of butadiene as a monomer and 0.2 parts by weight of tertiary dodecylmercaptan as a molecular weight adjuster were added thereto and polymerized at 50° C. to obtain a c ore polymer for a rubber latex.

The monomer-to-polymer conversion ratio, measured by a weight method, was 83 wt %, and the gel content of the core polymer was 72%.

For shell polymerization, 50 parts by weight of butadiene, 0.2 parts by weight of potassium oleic acid, 0.02 parts by weight of sodium formaldehyde sulfoxylate, 0.11 parts by weight of diisopropylbenzene hydroperoxide, and 0.5 parts by weight of divinylbenzene as a crosslinking agent were added to the core polymer and polymerized at 50° C. to obtain a rubber latex with a particle size of 960 Å. The overall monomer-to-polymer conversion ratio was 96 wt % and the gel content of the rubber latex finally obtained was 93%.

### COMPARATIVE EXAMPLE a2

To a high-pressure polymerization reactor equipped with a stirrer, there were added 250 parts by weight of ion exchange water, 0.8 parts by weight of potassium oleic acid, 0.065 parts by weight of sodium pyrophosphate, 0.0047 parts by weight of ethylenediamine sodium tetraacetate, 0.003 parts by weight of ferrous sulfuric acid, 0.02 parts by weight of sodium formaldehyde sulfoxylate, and 0.11 parts by weight of diisopropylbenzene hydroperoxide. Then, 100 parts by weight of butadiene as a monomer and 0.2 parts by weight of tertiary dodecylmercaptan were added thereto and polymerized at 50° C. to obtain a core polymer for a rubber latex.

When the monomer-to-polymer conversion ratio reached 50%, 0.2 parts by weight of potassium oleic acid, 0.02 parts by weight of sodium formaldehyde sulfoxylate, 0.11 parts by weight of diisopropylbenzene hydroperoxide, and 0.2 parts by weight of tertiary dodecylmercaptan were added to the core polymer and polymerized at 50° C. to obtain a rubber latex with a particle size of 990 Å. The overall monomer-to-polymer conversion ratio was 88 wt % and the gel content of the rubber latex finally obtained was 72%.

### COMPARATIVE EXAMPLE a3-a5

Rubber latexes were prepared in the same manner as in Comparative Example a2 except that the compositions and contents of components were as given in Table 2 below.

### COMPARATIVE EXAMPLE a6

A rubber latex was prepared in the same manner as in Comparative Example a1 except that the compositions and contents of components were as given in Table 2 below.

### COMPARATIVE EXAMPLES a7-a10

Rubber latexes were prepared in the same manner as in Comparative Example a2 except that the compositions and contents of components were as given in Table 2 below.

TABLE 2

| Section | | Comp. a1 | Comp. a2 | Comp. a3 | Comp. a4 | Comp. a5 |
|---|---|---|---|---|---|---|
| Core | Ion exchange water | 250 | 250 | 250 | 150 | 150 |
| | Potassium oleic acid | 0.8 | 0.8 | 0.8 | 0.4 | 0.4 |
| | Sodium pyrophosphate | 0.065 | 0.065 | 0.065 | 0.065 | 0.065 |
| | Ethylenediamine sodium tetraacetate | 0.0047 | 0.0047 | 0.0047 | 0.047 | 0.0047 |
| | Ferrous sulfuric acid | 0.003 | 0.003 | 0.003 | 0.003 | 0.003 |
| | Sodium formaldehyde sulfoxylate | 0.02 | 0.02 | 0.02 | 0.002 | 0.02 |
| | Diisopropylbenzene hydroperoxide | 0.11 | 0.11 | 0.11 | 0.11 | 0.11 |
| | Butadiene | 50 | 100 | 100 | 100 | 100 |
| | Styrene | 0 | 0 | 0 | 0 | 0 |
| | Divinylbenzene | 0 | 0 | 0.5 | 0 | 0.5 |
| | Tertiary dodecylmercaptan | 0.2 | 0.2 | 0 | 0.2 | 0 |
| | Monomer to polymer conversion ratio | 83 | | | | |
| | (wt %) | | | | | |
| | Gel content (%) | 72 | | | | |
| Shell | Potassium oleic acid | 0.2 | 0.2 | 0.2 | 0.2 | 0.2 |
| | Sodium formaldehyde sulfoxylate | 0.02 | 0.02 | 0.02 | 0.02 | 0.02 |
| | Diisopropylbenzene hydroperoxide | 0.11 | 0.11 | 0.11 | 0.11 | 0.11 |
| | Butadiene | 50 | 0 | 0 | 0 | 0 |
| | Styrene | 0 | 0 | 0 | 0 | 0 |
| | Divinylbenzene | 0.5 | 0 | 0 | 0 | 0 |
| | Tertiary dodecylmercaptan | 0 | 0.2 | 0.2 | 0.2 | 0.2 |
| | Monomer to polymer conversion ratio | 96 | 88 | 92 | 83 | 94 |
| | (wt %) | | | | | |
| | Particle size (Å) | 960 | 990 | 980 | 1980 | 2020 |
| | Final gel content (%) | 93 | 72 | 97 | 69 | 96 |

| Section | | Comp. a6 | Comp. a7 | Comp. a8 | Comp. a9 | Comp. a10 |
|---|---|---|---|---|---|---|
| Core | Ion exchange water | 250 | 250 | 250 | 150 | 150 |
| | Potassium oleic acid | 0.8 | 0.8 | 0.8 | 0.4 | 0.4 |
| | Sodium pyrophosphate | 0.065 | 0.065 | 0.065 | 0.065 | 0.065 |
| | Ethylenediamine sodium tetraacetate | 0.0047 | 0.0047 | 0.0047 | 0.0047 | 0.0047 |
| | Ferrous sulfuric acid | 0.003 | 0.003 | 0.003 | 0.003 | 0.003 |
| | Sodium formaldehyde sulfoxylate | 0.02 | 0.02 | 0.02 | 0.02 | 0.02 |
| | Diisopropylbenzene hydroperoxide | 0.11 | 0.11 | 0.11 | 0.11 | 0.11 |
| | Butadiene | 35 | 80 | 80 | 80 | 80 |
| | Styrene | 15 | 20 | 20 | 20 | 20 |
| | Divinylbenzene | 0 | 0 | 0.5 | 0 | 0.5 |
| | Tertiary dodecylmereaptan | 0.2 | 0.2 | 0 | 0.2 | 0 |
| | Monomer to polymer conversion ratio | 85 | | | | |
| | (wt %) | | | | | |
| | Gel content (%) | 74 | | | | |
| Shell | Potassium oleic acid | 0.2 | 0.2 | 0.2 | 0.2 | 0.2 |
| | Sodium formaldehyde sulfoxylate | 0.02 | 0.02 | 0.02 | 0.02 | 0.02 |
| | Diisopropylbenzene hydroperoxide | 0.11 | 0.11 | 0.11 | 0.11 | 0.11 |
| | Butadiene | 45 | 0 | 0 | 0 | 0 |
| | Styrene | 5 | 0 | 0 | 0 | 0 |
| | Divinylbenzene | 0.2 | 0 | 0 | 0 | 0 |
| | Tertiary dodecylmercaptan | 0 | 0.2 | 0.2 | 0.2 | 0.2 |
| | Monomer to polymer conversion ratio | 96 | 89 | 96 | 84 | 95 |
| | (wt %) | | | | | |
| | Particle size (Å) | 970 | 980 | 970 | 2010 | 2050 |
| | Final gel content (%) | 92 | 74 | 98 | 71 | 97 |

Component unit: parts by weight
Comp.: Comparative Example

### EXAMPLE a5

Fusion of Rubber Latex Particles

100 parts by weight of the rubber latex prepared in Example al was placed in a reaction bath which was then set to an agitation speed of 10 rpm and a reaction temperature of 30° C. After addition of 0.2 parts by weight of a 3% sodium dodecylbenzene sulfonate, 1.0 part by weight of a 5% acetic acid solution was gradually added to the reaction mixture for 1 hour. Then, the reaction mixture was left stand for 30 minutes without stirring to obtain a rubber latex with a particle size of 2,000 Å. The rubber latex thus prepared was used as a substrate for an impact modifier after being stabilized by a 10% KOH aqueous solution.

### EXAMPLE a6

Fusion of Rubber Latex Particles

A rubber latex was prepared in the same manner as in Example a5 except using the rubber latex of Example a3 instead of the rubber latex of Example a1.

### COMPARATIVE EXAMPLE a11

Fusion of Rubber Latex Particles

100 parts by weight of the rubber latex prepared in Comparative Example a1 was placed in a reaction bath which was then set to an agitation speed of 10 rpm and a reaction temperature of 30° C. After addition of 0.2 parts by weight of a 3% sodium dodecylbenzene sulfonate, 1.0 part by weight of a 5% acetic acid solution was gradually added to the reaction mixture for 1 hour. The reaction mixture was left stand for 30 minutes without stirring to obtain a rubber latex with a particle size of 2,050 Å. The rubber latex thus prepared was used as a substrate for an impact modifier after being stabilized by a 10% KOH aqueous solution.

### COMPARATIVE EXAMPLES a12-a16

Fusion of Rubber Latex Particles

Rubber latexes were prepared in the same manner as in Comparative Example a11 except using the rubber latexes of Comparative Examples a2, a3, a6, a7, and a8 instead of the rubber latex of Comparative Example a1.

TABLE 3

| Section | Exam. a5 | Exam. a6 | Comp. a11 | Comp. a12 | Comp. a13 | Comp. a14 | Comp. a15 | Comp. a16 |
|---|---|---|---|---|---|---|---|---|
| Rubber latex | Exam. a1 | Exam. a3 | Comp. a1 | Comp. a2 | Comp. a3 | Comp. a6 | Comp. a7 | Comp. a8 |
| | 100 | 100 | 100 | 100 | 100 | 100 | 100 | 100 |
| Sodium dodecylbenzene | 0.2 | 0.2 | 0.2 | 0.2 | 0.2 | 0.2 | 0.2 | 0.2 |
| sulfonate | | | | | | | | |
| Acetic acid solution | 1 | 1 | 1 | 1 | 1 | 1 | 1 | 1 |
| KOH aqueous solution | 0.8 | 0.8 | 0.8 | 0.8 | 0.8 | 0.8 | 0.8 | 0.8 |
| Particle size (Å) | 2000 | 2150 | 2050 | 2200 | 2100 | 2150 | 2200 | 2150 |

Component unit: parts by weight
Exam.: Example,
Comp.: Comparative Example

### EXAMPLES b1-b4 AND COMPARATIVE EXAMPLES b1-b10

Preparation of Impact Modifier Powders

Impact modifiers for polyvinylchloride were prepared by graft polymerization using as substrates the rubber latexes of Examples a2 and a5, and Comparative Examples a4, a5, a11, a12, and a13, and the physical properties of the impact modifiers were evaluated.

In Examples b1 and b2 and Comparative Examples b1-b5, to 70 parts by weight of the respective rubber latex solids of Examples a2 and a5 and Comparative Examples a4, a5, a11, a12, and a13, there were added 100 parts by weight of water, 0.009 parts by weight of ethylenediamine sodium tetraacetate, 0.005 parts by weight of ferrous sulfuric acid, 0.03 parts by weight of sodium formaldehyde sulfoxylate, and 0.2 parts by weight of potassium peroxide. Then, polymerization was performed as follows: polymerization for 30 minutes after addition of 25 parts by weight of methyl methacrylate at 80° C. for 120 minutes, addition of 0.1 parts by weight of potassium peroxide, and then polymerization for 60 minutes after addition of 5 parts by weight of styrene at 80° C. for 45 minutes, to thereby obtain graft copolymer latexes.

In Examples b3 and b4 and Comparative Examples b6-b10, to 85 parts by weight of the respective rubber latex solids of Examples a2 and a5 and Comparative Examples a4, a5, a11, a12, and a13, there were added 100 parts by weight of water, 0.005 parts by weight of ethylenediamine sodium tetraacetate, 0.003 parts by weight of ferrous sulfuric acid, 0.02 parts by weight of sodium formaldehyde sulfoxylate, and 0.15 parts by weight of potassium peroxide. Then, polymerization was performed as follows: polymerization for 30 minutes after addition of 12 parts by weight of methyl methacrylate at 80° C. for 120 minutes, addition of 0.1 parts by weight of potassium peroxide, and then polymerization for 60 minutes after addition of 3 parts by weight of styrene at 80° C. for 30 minutes, to thereby obtain graft copolymer latexes.

The graft copolymer latexes were subjected to addition of an antioxidant and a magnesium sulfate and thermal treatment with stirring to separate polymers and water. The polymers were dehydrated and dried to obtain impact modifier powders for polyvinylchloride.

Measurement of Physical Properties of Impact Modifiers

The physical properties of the impact modifiers for polyvinylchloride were measured as follows. 5 parts by weight of each of the impact modifiers prepared in the above Examples was added to a mixture composed of 1.00 parts by weight of polyvinylchloride (degree of polymerization: 800), 1.8 parts by weight of a tin maleate stabilizer, 1.5 parts by weight of an internal lubricant, 0.4 parts by weight of an external lubricant, 1.0 part by weight of a processing aid, and 0.5 parts by weight of a blue pigment. Then, the resultant mixture was sufficiently melted by kneading in a 190° C. Roll-Mill for 3 minutes to produce 0.5 mm thick sheets which were then made into 3 mm thick sheets by a hot press.

The 3 mm thick sheets were delicately cut into test samples for a notched Izod impact test (ASTM), and impact strengths of the test samples were measured.

TABLE 4

| | Exam. | Exam. | Exam. | Exam. | Comp. | Comp. | Comp. | Comp. | Comp. | Comp. | Comp. | Comp. | Comp. | Comp. |
|---|---|---|---|---|---|---|---|---|---|---|---|---|---|---|
| Section | b1 | b2 | b3 | b4 | b1 | b2 | b3 | b4 | b5 | b6 | b7 | b8 | b9 | b10 |
| Rubber latex | Exam. | Exam. | Exam. | Exam. | Comp. | Comp. | Comp. | Comp. | Comp. | Comp. | Comp. | Comp. | Comp. | Comp. |
| (pbw) | a2 | a5 | a2 | a5 | a4 | a5 | a11 | a12 | a13 | a4 | a5 | a11 | a12 | a13 |
| | 70 | 70 | 85 | 85 | 70 | 70 | 70 | 70 | 70 | 85 | 85 | 85 | 85 | 85 |
| Izod | 42 | 55 | 82 | 98 | 45 | 28 | 39 | 52 | 31 | 5 | 44 | 57 | 7 | 52 |
| Impact strength | | | | | | | | | | | | | | |

Izod impact strength (Kg cm/cm): 20° C.;
pbw: parts by weight
Exam: Example,
Comp.: Comparative Example

As can be seen from Table 4, in connection with the test samples of Comparative Examples b6 and b9 in which a rubber content was 85 parts by weight and the gel content of the rubber latex particles was lower than that of Examples according to the present invention, no dispersion on the matrix resins occurred due to the limitation of grafting, thereby producing a large number of agglomerations (called fisheyes). Furthermore, in connection with the test samples of Comparative Examples b7, b8, and b10 in which the gel content of the rubber latex particles was higher than that of Examples according to the present invention, impact strengths were not significantly increased even at an increased rubber content.

### EXAMPLES c1 AND c2 AND COMPARATIVE EXAMPLES c1-c6

Preparation of Impact Modifier Powders

Impact modifiers for polyvinylchloride were prepared by graft polymerization using as substrates the rubber latexes of Example a4 and Comparative Examples a1, a2, and a3, and the physical properties of the impact modifiers were evaluated.

In Examples c1 and Comparative Examples c1-c3, to 65 parts by weight of the respective rubber latex solids of Example a4 and Comparative Examples a1, a2, and a3, there were added 100 parts by weight of water, 0.009 parts by weight of ethylenediamine sodium tetraacetate, 0.005 parts by weight of ferrous sulfuric acid, 0.03 parts by weight of sodium formaldehyde sulfoxylate, and 0.2 parts by weight of potassium peroxide. Then, polymerization was performed as follows: polymerization for 60 minutes after addition of 13 parts by weight of methyl methacrylate at 80° C. for 60 minutes, addition of 0.2 parts by weight of potassium peroxide, and then polymerization for 120 minutes after addition of 22 parts by weight of styrene for 120 minutes, to thereby obtain graft copolymer latexes.

The graft copolymer latexes were subjected to addition of an antioxidant and a magnesium sulfate and thermal treatment with stirring to separate polymers and water. The polymers were dehydrated and dried to obtain impact modifier powders for polyvinylchloride.

In Examples c2 and Comparative Examples c4-c6, to 75 parts by weight of the respective rubber latex solids of Example a4 and Comparative Examples a1, a2, and a3, there were added 100 parts by weight of water, 0.009 parts by weight of ethylenediamine sodium tetraacetate, 0.005 parts by weight of ferrous sulfuric acid, 0.03 parts by weight of sodium formaldehyde sulfoxylate, and 0.2 parts by weight of potassium peroxide. Then, polymerization was performed as follows: polymerization for 60 minutes after addition of 8 parts by weight of methyl methacrylate at 80° C. for 60 minutes, addition of 0.2 parts by weight of potassium peroxide, and then polymerization for 120 minutes after addition of 17 parts by weight of styrene for 120 minutes, to thereby obtain graft copolymer latexes.

The graft copolymer latexes were subjected to addition of an antioxidant and a magnesium sulfate and thermal treatment with stirring to separate polymers and water. The polymers were dehydrated and dried to obtain impact modifier powders for polyvinylchloride.

Measurement of Physical Properties of Impact Modifiers

The physical properties of the impact modifiers for polyvinylchloride were measured as follows. 7 parts by weight of each of the impact modifiers prepared in the above Examples was added to a mixture composed of 100 parts by weight of polyvinylchloride (degree of polymerization: 800), 1.8 parts by weight of a tin maleate stabilizer, 1.5 parts by weight of an internal lubricant, 0.4 parts by weight of an external lubricant, 1.0 part by weight of a processing aid, and 0.5 parts by weight of a blue pigment. Then, the resultant mixture was sufficiently melted by kneading in a 190° C. Roll-Mill for 3 minutes to produce 0.5 mm thick sheets which were then made into 3 mm thick sheets by a hot press.

The 3 mm thick sheets were delicately cut into test samples to measure light transmittance and haze values by a haze meter (ASTM). The test samples were also used for a notched Izod impact test (ASTM) to measure impact strengths.

TABLE 5

| | Exam. | Exam. | Comp. | Comp. | Comp. | Comp. | Comp. | Comp. |
|---|---|---|---|---|---|---|---|---|
| Section | c1 | c2 | c1 | c2 | c3 | c4 | c5 | c6 |
| Rubber latex | Exam. a4 | Exam. a4 | Comp. a1 | Comp. a2 | Comp. a3 | Comp. a1 | Comp. a2 | Comp. a3 |
| (pbw) | 65 | 75 | 65 | 65 | 65 | 75 | 75 | 75 |
| Izod | 44 | 78 | 37 | 48 | 29 | 52 | 12 | 42 |
| Impact strength | | | | | | | | |
| Light | 85 | 82 | 87 | 83 | 88 | 81 | 65 | 86 |
| transmittance | | | | | | | | |
| Haze | 3.2 | 4.2 | 3.1 | 3.5 | 2.7 | 4.1 | 9.5 | 3.7 |

Izod impact strength (Kg cm/cm): 20° C.;
pbw: parts by weight
Exam.: Example,
Comp.: Comparative Example

As can be seen from Table 5, in connection with the test sample of Comparative Examples c5 in which a rubber content was 75 parts by weight and the gel content of the rubber latex particles was lower than that of Examples according to the present invention, no dispersion on the matrix resin occurred due to the limitation of grafting, thereby producing a large number of agglomerations (called fisheyes). Furthermore, in connection with the test samples of Comparative Examples c4 and c6 in which the gel content of the rubber latex particles was higher than that of Examples according to the present invention, impact strengths were not significantly increased even at an increased rubber content.

### EXAMPLES d1-d4 AND COMPARATIVE EXAMPLES d1-d6

Preparation of Impact Modifier Powders

Impact modifiers for polycarbonate were prepared by graft polymerization using as substrates the rubber latexes of Example a2 and as and Comparative Examples a11, a12, and a13, and the physical properties of the impact modifiers were evaluated.

In Examples d1 and d2 and Comparative Examples d1-d3, 70 parts by weight of the respective rubber latex solids of Example a2 and a5 and Comparative Examples a11, a12, and a13 were added to a reactor. 9 parts by weight of methyl methacrylate, 0.002 parts by weight of allyl methacrylate, and 0.001 parts by weight of divinylbenzene were placed in a tank 1 and stirred. 16 parts by weight of styrene, 5 parts by weight of acrylonitrile, 0.01 parts by weight of allyl methacrylate, and 0.005 parts by weight of divinylbenzene were placed in a tank 2 and stirred. The reaction mixture of the tank 1 was set in such a way to be continuously supplied into the reactor for 30 minutes.

When the content of the reaction mixture in the tank 1 was reduced to 50%, the reaction mixture of the tank 2 was continuously supplied into the tank 1 so that the reaction mixtures in the tanks 1 and 2 were mixed and then supplied into the reactor.

During the supply of the reaction mixture of the tank 1 into the reactor, 0.2 parts by weight of SFS (sodium formaldehyde sulfoxylate) and 0.1 parts by weight of t-butyl hydroperoxide were continuously supplied into the reactor. At this time, SFS was supplied into the reactor in the state of a 3% aqueous solution. Nitrogen washing was continued until the reaction was terminated. After completing the supply of all components into the reactor, the resultant reaction solution was aged for at least 1 hour.

Graft latexes thus obtained were subjected to addition of an antioxidant and a sulfuric acid and thermal treatment with stirring to separate polymers and water. The polymers were dehydrated and dried to obtain impact modifier powders.

In Examples d3 and d4, and Comparative Examples d4-d6, 80 parts by weight of the respective rubber latex solids of Example a2 and as and Comparative Examples a11, a12, and a13 were added to a reactor. 6.5 parts by weight of methyl methacrylate, 0.002 parts by weight of allyl methacrylate, and 0.001 parts by weight of divinylbenzene were placed in a tank 1 and stirred. 10 parts by weight of styrene, 3.5 parts by weight of acrylonitrile, 0.01 parts by weight of allyl methacrylate, and 0.005 parts by weight of divinylbenzene were placed in a tank 2 and stirred. The reaction mixture of the tank 1 was set in such a way to be continuously supplied into the reactor for 30 minutes.

When the content of the reaction mixture in the tank 1 was reduced to 50%, the reaction mixture of the tank 2 was continuously supplied into the tank 1 so that the reaction mixtures in the tanks 1 and 2 were mixed and then supplied into the reactor.

During the supply of the reaction mixture of the tank 1 into the reactor, 0.2 parts by weight of SFS and 0.1 parts by weight of t-butyl hydroperoxide were continuously supplied into the reactor. At this time, SFS was supplied into the reactor in the state of a 3% aqueous solution. Nitrogen washing was continued until the reaction was terminated. After completing the supply of all components into the reactor, the resultant reaction solution was aged for at least 1 hour.

Graft latexes thus obtained were subjected to addition of an antioxidant and a sulfuric acid and thermal treatment with stirring to separate polymers and water. The polymers were dehydrated and dried to obtain impact modifier powders.

Polycarbonate (manufactured by LG Dow) was used as a matrix resin. Each impact modifier was used in an amount of 5 parts by weight, based on 100 parts by weight of the polycarbonate resin. In addition, processing additives and a pigment were respectively used in an amount of 0.5 and 0.02 parts by weight, based on 100 parts by weight of the polycarbonate resin. The resin compositions were subjected to extrusion and injection to thereby obtain test samples for impact strength tests.

TABLE 6

| | Exam. | Exam. | Exam. | Exam. | Comp. | Comp. | Comp. | Comp. | Comp. | Comp. |
|---|---|---|---|---|---|---|---|---|---|---|
| Section | d1 | d2 | d3 | d4 | d1 | d2 | d3 | d4 | d5 | d6 |
| Rubber latex | Exam. | Exam. | Exam. | Exam. | Comp. | Comp. | Comp. | Comp. | Comp. | Comp. |
| (pbw) | a2 | a5 | a2 | a5 | a11 | A12 | a13 | a11 | a12 | a13 |
| | 70 | 70 | 80 | 80 | 70 | 70 | 70 | 80 | 80 | 80 |
| Izod impact strength | 32 | 37 | 62 | 68 | 31 | 39 | 21 | 45 | 12 | 35 |
| (0° C.) | | | | | | | | | | |
| Izod impact strength | 18 | 20 | 37 | 42 | 14 | 25 | 9 | 27 | 3 | 18 |
| (−20° C.) | | | | | | | | | | |

Izod impact strength (Kg cm/cm): at 0° C. and −20° C., ⅛″;
pbw: parts by weight
Exam.: Example;
Comp.: Comparative Example

In connection with the test sample of Comparative Example d5 in which a rubber content was more than 75 parts by weight and the gel content of the rubber latex particles was lower than that of Examples according to the present invention, no dispersion on the matrix resin occurred due to the limitation of grafting, thereby lowering an impact strength. Further, in connection with the test samples of Comparative Examples d4 and d6 in which the gel content of the rubber latex particles was higher than that of Examples according to the present invention, impact strengths were not significantly increased even at an increased rubber content.

### EXAMPLES e1-e4 AND COMPARATIVE EXAMPLES e1-e10

Preparation of Impact Modifier Powders

Impact modifiers for polycarbonate resins were prepared by graft polymerization using as substrates the rubber latexes of Example a4 and a6 and Comparative Examples a4, a5, a14, a15, and a16, and the physical properties of the impact modifiers were evaluated.

In Examples e1 and e2 and Comparative Examples e1-e5, to 70 parts by weight of the respective rubber latex solids of Examples a4 and a6 and Comparative Examples a4, a5, a14, a15, and a16, there were added 100 parts by weight of water, 0.009 parts by weight of ethylenediamine sodium tetraacetate, 0.005 parts by weight of ferrous sulfuric acid, 0.03 parts by weight of sodium formaldehyde sulfoxylate, and 0.2 parts by weight of cumene hydroperoxide. Then, polymerization was performed as follows: polymerization for 60 minutes after addition of a mixture of 15 parts by weight of methyl methacrylate and 5 parts by weight of butyl acrylate at 70° C. for 120 minutes, addition of 0.2 parts by weight of cumene hydroperoxide, and polymerization for 120 minutes after addition of 15 parts by weight of styrene for 120 minutes, to thereby obtain graft copolymer latexes.

The graft copolymer latexes were subjected to addition of an antioxidant and a sulfuric acid and thermal treatment with stirring to separate polymers and water. The polymers were dehydrated and dried to obtain impact modifier powders.

In Examples e3 and e4 and Comparative Examples e6-e10, to 80 parts by weight of the respective rubber latex solids of Examples a4 and a6 and Comparative Examples a4, a5, a14, a15, and a16, there were added 100 parts by weight of water, 0.009 parts by weight of ethylenediamine sodium tetraacetate, 0.005 parts by weight of ferrous sulfuric acid, 0.03 parts by weight of sodium formaldehyde sulfoxylate, and 0.2 parts by weight of cumene hydroperoxide. Then, polymerization was performed as follows: polymerization for 60 minutes after addition of a mixture of 12 parts by weight of methyl methacrylate and 3 parts by weight of butyl acrylate at 70° C. for 120 minutes, addition of 0.2 parts by weight of cumene hydroperoxide, and polymerization for 120 minutes after addition of 10 parts by weight of styrene for 120 minutes, to thereby obtain graft copolymer latexes.

The graft copolymer latexes were subjected to addition of an antioxidant and a sulfuric acid and thermal treatment with stirring to separate polymers and water. The polymers were dehydrated and dried to obtain impact modifier powders.

For preparation of resin compositions, 65 parts by weight of a polycarbonate resin (LG Dow) and 35 parts by weight of a polyethylene terephthalate resin (Kanebo, Ltd.) were used. Each impact modifier prepared in the above Examples was used in an amount of 10 parts by weight. In addition, processing additives and a pigment were respectively used in an amount of 0.5 and 0.02 parts by weight, based on 100 parts by weight of the polycarbonate resin. The resin compositions were subjected to extrusion and injection to obtain test samples for impact strength tests.

TABLE 7

| | Exam. | Exam. | Exam. | Exam. | Comp. | Comp. | Comp. | Comp. | Comp. | Comp. | Comp. | Comp. | Comp. | Comp. |
|---|---|---|---|---|---|---|---|---|---|---|---|---|---|---|
| Section | e1 | e2 | e3 | e4 | e1 | e2 | e3 | e4 | e5 | e6 | e7 | e8 | e9 | e10 |
| Rubber | Exam. | Exam. | Exam. | Exam. | Comp. | Comp. | Comp. | Comp. | Comp. | Comp. | Comp. | Comp. | Comp. | Comp. |
| latex | a4 | a6 | a4 | a6 | a4 | a5 | a14 | a15 | a16 | a4 | a5 | a14 | a15 | a16 |
| (pbw) | 70 | 70 | 80 | 80 | 70 | 70 | 70 | 70 | 70 | 80 | 80 | 80 | 80 | 80 |
| Izod | 65 | 74 | 85 | 102 | 70 | 45 | 60 | 75 | 51 | 19 | 55 | 72 | 24 | 61 |
| impact | | | | | | | | | | | | | | |
| strength | | | | | | | | | | | | | | |
| (0° C.) | | | | | | | | | | | | | | |
| Izod | 29 | 35 | 49 | 63 | 40 | 14 | 25 | 44 | 17 | 3 | 21 | 35 | 3 | 22 |
| impact | | | | | | | | | | | | | | |
| strength | | | | | | | | | | | | | | |
| (−20° C.) | | | | | | | | | | | | | | |

Izod impact strength (Kg cm/cm): at 0° C. and −20° C., ⅛″;
pbw: parts by weight
Exam: Example;
Comp.: Comparative Example

In connection with the test samples of Comparative Examples e6 and e9 in which a rubber content was more than 75 parts by weight and the gel content of the rubber latex particles was lower than that of Examples according to the present invention, no dispersion on the matrix resins occurred due to the limitations of grafting, thereby lowering impact strengths. Furthermore, in connection with the test samples of Comparative Examples e7, e8, and e10 in which the gel content of the rubber latex particles was higher than that of Examples according to the present invention, impact strengths were not significantly increased even at an increased rubber content.

### INDUSTRIAL APPLICABILITY

As apparent from the above description, a rubber latex according to the present invention is prepared by two-step or multi-step polymerization to have a decreasing gel content from a core to a shell(s). The rubber latex can be used as a substrate for a high efficiency impact modifier with high rubber content and enhanced impact strength and processability.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A rubber latex comprising a rubber monomer as a main component,
wherein the rubber latex is composed of a core and one or more shell(s), and has a decreasing gel content from the core to the shell(s) and a gel content of 85 to 95%. and a gel content of the core is 90 to 100%.

2. (canceled)

3. The rubber latex of claim 1, wherein an average gel content of the shell(s) is 70 to 90%.

4. The rubber latex of claim 1, wherein an average particle size of the rubber latex is 800 to 5,000 Å.

5. The rubber latex of claim 1, wherein the rubber monomer is one or more selected from the group consisting of 1,3-butadiene, isoprene, chloroprene, piperylene, arid a comonomer thereof alkyl acrylate; and silicon-based monomer.

6. A method for preparing a rubber latex having a gel content of 85 to 95% and comprising a rubber monomer as a main component, the method comprising:
polymerizing a core; and
polymerizing one or more shell(s) onto the core so that the shell(s) have a lower gel content than the core.

7. The method of claim 6, wherein in the shell polymerization, one up to five shell(s) are formed so that the rubber latex has a decreasing gel content from the core to the shell(s).

8. The method of claim 6, further comprising particle size enlargement of the rubber latex after the shell polymerization.

9. An impact modifier prepared by graft polymerization using as a substrate a rubber latex prepared by the method of claim 6.

10. The impact modifier of claim 9, wherein the impact modifier is used for a thermoplastic resin or a thermosetting resin.

11. The impact modifier of claim 10, wherein the thermoplastic resin is one or more selected from the group consisting of acrylonitrile butadiene styrene, styrene acrylonitrile copolymer, methylmethacrylate polymer, polyvinylchloride, polycarbonate, polyester, and polyamide.

12. The impact modifier of claim 10, wherein the thermosetting resin is an epoxy resin.
